(19) United States
(12) Patent Application Publication
(10) Pub. No.: US 2004/0222712 A1
(43) Pub. Date: Nov. 11, 2004

(54) Composite stator and base for a low profile spindle motor

(76) Inventors: YiRen Hong, Scotts Valley, CA (US); Mo Xu, Scotts Valley, CA (US); PohLye Lim, Scotts Valley, CA (US)

Correspondence Address: WAX LAW GROUP, 2118 WILSHIRE BOULEVARD, SUITE 407, SANTA MONICA, CA, 90403, US

(21) Appl. No.: 10/695,253

(22) Filed: Oct. 27, 2003

Related U.S. Application Data
(60) Provisional application No. 60/468,379, filed on May 5, 2003.

(51) Int. Cl. H02K 1/04; H02K 7/00

(52) U.S. Cl. 310/67 R; 360/99.08; 310/43

(57) ABSTRACT

An axially minimized spindle motor is provided that meets industry demands for low profile disc drive memory systems including stiffness, vibration and acoustic demands. Axial height of a base plate is reduced by forming a composite component of the stator and base plate. A thermally conductive bonding substance unites the stator and base plate, and fills in at least a portion of open space adjacent the base plate and stator. By making such a composite component, the axial thickness of the base plate may be reduced. In an aspect, a base plate is provided having an axial height adjacent to a stator in the range of 0.1 mm to 0.3 mm with improved stiffness, reduced vibration and reduced acoustics as compared to conventional low profile disc drive designs.

### CROSS REFERENCE TO RELATED APPLICATION

This application is based on a provisional application serial No. 60/468,379, filed May 5, 2003, attorney docket number STL3361.01, entitled Using Epoxy To Fill HDD Motor Stator For Thin Base And Improving Performance, and assigned to the Assignee of this application and incorporated herein by reference.

### FIELD OF THE INVENTION

The invention relates generally to spindle motors, and more particularly to reducing axial height by forming a composite component for low profile disc drive memory systems.

### BACKGROUND OF THE INVENTION

The demands on disc drive memory systems have intensified because of new environments for usage, miniaturization and increased performance needs. Besides traditional computing environments, disc drive memory systems are used more recently by devices including digital cameras, digital video recorders, laser printers, photo copiers, jukeboxes, video games and personal music players.

Disc drive memory systems store digital information that is recorded on concentric tracks of a magnetic disc medium. Several discs are rotatably mounted on a spindle, and the information, which can be stored in the form of magnetic transitions within the discs, is accessed using read/write heads or transducers. A drive controller is conventionally used for controlling the disc drive system based on commands received from a host system. The drive controller controls the disc drive to store and retrieve information from the magnetic discs. The read/write heads are located on a pivoting arm that moves radially over the surface of the disc. The discs are rotated at high speeds during operation using an electric motor located inside a hub or below the discs. Magnets on the hub interact with a stator to cause rotation of the hub relative to the shaft. One type of motor is known as an in-hub or in-spindle motor, which typically has a spindle mounted by means of a bearing system to a motor shaft disposed in the center of the hub. The bearings permit rotational movement between the shaft and the hub, while maintaining alignment of the spindle to the shaft. The read/write heads must be accurately aligned with the storage tracks on the disc to ensure the proper reading and writing of information.

Spindle motors have in the past used conventional ball bearings between the hub and the shaft. However, the demand for increased storage capacity and smaller disc drives has led to the design of higher recording area density such that the read/write heads are placed increasingly closer to the disc surface. A slight wobble or run-out in disc rotation can cause the disc to strike the read/write head, possibly damaging the disc drive and resulting in loss of data. Conventional ball bearings exhibit shortcomings in regard to these concerns. Imperfections in the raceways and ball bearing spheres result in vibrations. Also, resistance to mechanical shock and vibration is poor in the case of ball bearings, because of low damping. Vibrations and mechanical shock can result in misalignment between data tracks and the read/write transducer. These shortcomings limit the data track density and overall performance of the disc drive system. Because this rotational accuracy cannot be achieved using ball bearings, disc drives currently utilize a spindle motor having fluid dynamic bearings between a shaft and sleeve to support a hub and the disc for rotation. One alternative bearing design is a hydrodynamic bearing.

In a hydrodynamic bearing, a lubricating fluid such as gas or liquid or air provides a bearing surface between a fixed member and a rotating member of the disc drive. Hydrodynamic bearings eliminate mechanical contact vibration problems experienced by ball bearing systems. Further, hydrodynamic bearings can be scaled to smaller sizes whereas ball bearings have smallness limitations. Demands of the market and advances in technology have lead to the reduction in the physical size of disc drives. Efforts have been made to design smaller profile disc drives without loss of performance. In reducing size, there is a trend to reduce the axial height of the fluid dynamic bearing motor. One reduced sized disc drive having a 5 mm thickness currently on the market is the one-inch disc drive used with a CF card type II form factor.

A demand exists for smaller mobile applications including smaller portable computers, and it has become essential in the industry to design disc drives having even smaller dimensions while maintaining motor stiffness. For example, a CF card type I form factor requires a disc drive having a 3.3 mm thickness but such disc drive does not currently exist. Space constraint and stiffness design issues currently remain unresolved. What is needed is a hard disc drive having a 3.3 mm thickness or less, which meets stiffness, vibration and acoustic requirements.

### SUMMARY OF THE INVENTION

An axially minimized spindle motor is provided that meets performance demands including stiffness, vibration and acoustic requisites. In an embodiment, a base plate is provided having an axial height adjacent to a stator of 0.3 mm with improved stiffness, reduced acoustics and reduced vibration as compared to base plates of conventional low profile disc drive designs. As compared to conventionally used base plates, a 0.3 mm minimally sized base plate with these qualities can reduce the smallest disc drives available on the market including the one inch disc drive. In another embodiment, a spindle motor axial height reduction of 0.4 mm is provided, which equates to a savings of about 12% of the total space in a 3.3 mm thickness low profile disc drive design. This significant space savings opens up a useful range of possibilities that can favorably impact disc drive performance.

Features of the invention are achieved in part by utilizing an epoxy to bind and fill in at least a portion of open space adjacent the base plate, stator and motor seal to make a composite component of the base plate, stator and motor seal. By making such a composite component, the axial thickness of the base plate may be reduced, stiffness is improved and vibration and acoustic noise is reduced. Further, in an embodiment, a portion of the stator is repositioned below an adjacent surface of the base plate to save axial space, wherein the base plate has a varied and minimized axial thickness. Additionally, a thermally conductive epoxy having high bonding strength is utilized to dissipate any heat from the motor coil. Further, the epoxy provides added dampening for the spindle motor.

Other features and advantages of this invention will be apparent to a person of skill in the art who studies the invention disclosure. Therefore, the scope of the invention will be better understood by reference to an example of an embodiment, given with respect to the following figures.

### BRIEF DESCRIPTION OF THE DRAWINGS

The foregoing aspects and many of the attendant advantages of this invention will become more readily appreciated by reference to the following detailed description, when taken in conjunction with the accompanying drawings, wherein:

FIG. 1 is a top plain view of a disc drive data storage system in which the present invention is useful, in an embodiment;

FIG. 2 is a sectional side view of a hydrodynamic bearing spindle motor with a rotating shaft used in a disc drive, in which the present invention is usefull;

FIG. 3 is a plain view of a stator of the kind used in the spindle motor as in FIG. 2;

FIG. 4A is a sectional side view of the hydrodynamic bearing spindle motor of FIG. 2, with a reduced axial height base plate, in an embodiment of the present invention;

FIG. 4B is a sectional side view of the hydrodynamic bearing spindle motor of FIG. 4A, with a portion of the base plate adjacent to the stator having a further reduced axial height, in an embodiment of the present invention;

FIG. 4C is a sectional side view of the hydrodynamic bearing spindle motor of FIG. 4B, with a portion of the stator repositioned below an adjacent surface of the base plate, wherein the base plate has a varied axial thickness, in an embodiment of the present invention;

FIG. 4D is a sectional side view of the hydrodynamic bearing spindle motor of FIG. 4A, with a portion of the base plate adjacent to the stator defining an opening and filled and sealed with epoxy, in an embodiment of the present invention;

FIG. 4E is a sectional side view of the hydrodynamic bearing spindle motor of FIG. 4D, with a portion of the stator repositioned below an adjacent surface of the base plate to reduce space, in an embodiment of the present invention;

FIG. 5A is a sectional view of a portion of rotating sleeve hydrodynamic bearing spindle motor with a reduced axial height base plate, and having a magnet positioned radially outside a stator, in an embodiment of the present invention; and

FIG. 5B is another view of the spindle motor of FIG. 5A in which the axial height of a portion of the base plate is further reduced, and a portion of the stator is repositioned below an adjacent surface of the base plate having a varied axial thickness, in an embodiment of the present invention.

### DETAILED DESCRIPTION OF THE INVENTION

Exemplary embodiments are described with reference to specific configurations. Those of ordinary skill in the art will appreciate that various changes and modifications can be made while remaining within the scope of the appended claims. Additionally, well-known elements, devices, components, methods and the like may not be set forth in detail in order to avoid obscuring the invention.

An apparatus and method is described herein for minimizing axial height of a spindle motor while providing needed stiffness and low acoustic vibration. In an embodiment, the axial thickness of the base plate adjacent to the stator is minimized. In another embodiment, a portion of the stator is repositioned below an adjacent surface of the base plate to save axial space, wherein the base plate has a varied and minimized axial thickness. In an embodiment, an epoxy binds and fills in at least a portion of a gap adjacent to a base plate and a stator, to make a composite component of the base plate and stator. It will be apparent that features of the discussion and claims may be utilized with disc drives, spindle motors, ball bearing designs, various fluid dynamic bearing designs including hydrodynamic and hydrostatic bearings, and other motors employing a stationary and a rotatable component. Further, embodiments of the present invention may be employed with a fixed shaft, rotating shaft, conical bearings, etc.

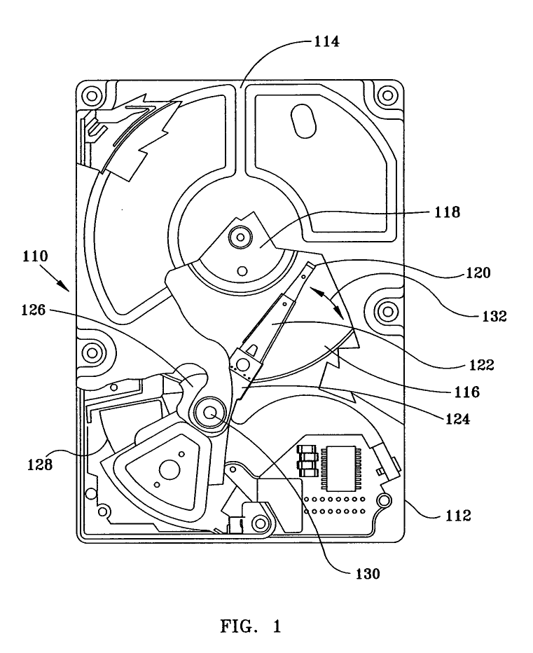

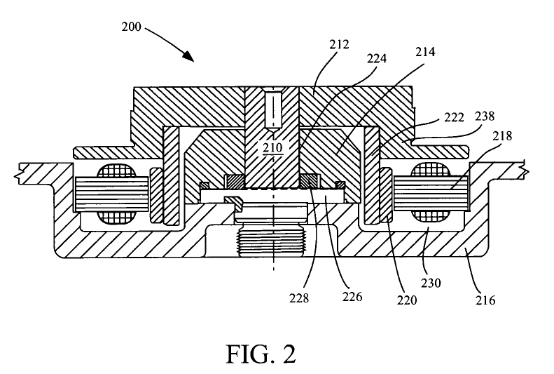

Referring to the drawings wherein identical reference numerals denote the same elements throughout the various views, FIG. 1 illustrates a typical disc drive data storage device 110 in which the present invention is useful. Clearly, features of the discussion and claims are not limited to this particular design, which is shown only for purposes of the example. Disc drive 110 includes housing base 112 that is combined with cover 114 forming a sealed environment to protect the internal components from contamination by elements outside the sealed environment. Disc drive 110 further includes disc pack 116, which is mounted for rotation on a spindle motor (described in FIG. 2) by disc clamp 118. Disc pack 116 includes a plurality of individual discs, which are mounted for co-rotation about a central axis. Each disc surface has an associated head 120 (read head and write head), which is mounted to disc drive 110 for communicating with the disc surface. In the example shown in FIG. 1, heads 120 are supported by flexures 122, which are in turn attached to head mounting arms 124 of actuator body 126. The actuator shown in FIG. 1 is a rotary moving coil actuator and includes a voice coil motor, shown generally at 128. Voice coil motor 128 rotates actuator body 126 with its attached heads 120 about pivot shaft 130 to position heads 120 over a desired data track along arcuate path 132. This allows heads 120 to read and write magnetically encoded information on the surfaces of discs 116 at selected locations.

FIG. 2 is a sectional side view of a low profile hydrodynamic bearing spindle motor 200 used in disc drives 110 (FIG. 1) in which the composite stator and base plate of the present invention is useful. Typically, spindle motor 200 includes a stationary component and a rotatable component. Spindle motor 200 incorporates a rotating shaft 210 in the design shown. The rotatable components include shaft 210, thrust plate 228, hub 212, backiron 222, and magnet 220. The stationary components include sleeve 214, counterplate 226, base plate 216 and stator 218. Although a rotating shaft is described herein, the present invention is useful with a rotating sleeve spindle motor design as well. Rotating shaft 210 rotates within a sleeve 214 having a bore. Sleeve 214 cooperates with an integral, single piece threaded counterplate 226 to define the bearing gap 224 within which shaft 210 rotates. Counterplate 226 cooperates with surfaces of thrust plate 228 to establish a fluid dynamic thrust bearing that supports shaft 210 for relative rotation. A fluid dynamic journal bearing is established in the gap or chamber 224 between the sleeve 214 and the rotating shaft 210 and the thrust plate 228 supported on the shaft 210. The shaft 210 and thrust plate 228 are supported for rotation by fluid between the surfaces of the shaft 210 and thrust plate 228, and the corresponding inner surfaces of the sleeve 214 and the threaded counterplate 226. These surfaces have patterns of grooves thereon to establish appropriate pressures in the fluid and support the shaft 210 for rotation. Shaft 210 and hub 212 additionally are affixed to backiron 222 and magnet 220, backiron 222 mounted to an end of shaft 210. Further, sleeve 214 and counterplate 226 are affixed to base plate 216. Hub 212 includes a central core and a disc carrier member 238, which supports disc pack 116 (shown in FIG. 1) for rotation about shaft 210. Disc pack 116 is held on disc carrier member 238 by disc clamp 118.

Stator and Magnet Interaction

Hub 212 carries magnet 220, forming a rotor for spindle motor 200. Magnet 220 can be formed as a unitary, annular ring or can be formed of a plurality of individual magnets that are spaced about the periphery of hub 212. Magnet 220 is magnetized to form one or more magnetic poles. Stator 218 is coaxial with magnet 220 and has a radial position that is external to magnet 220 with respect to a central axis.

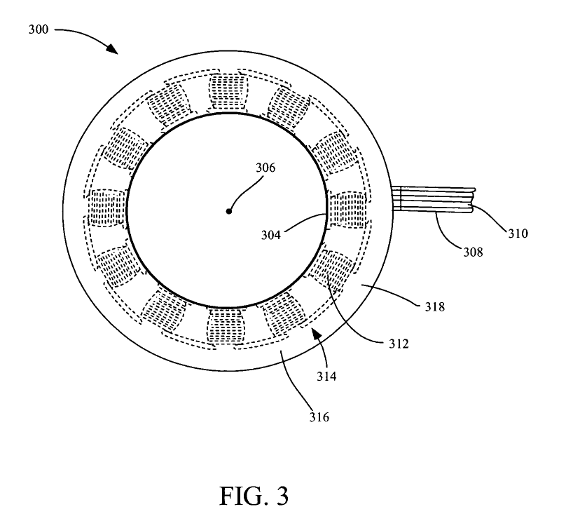

Referring to FIG. 3, a plain view of a stator is illustrated of the kind used in the spindle motor as in FIG. 2. Stator 300 includes stator laminations 314 comprising a back-iron 316 and a plurality of teeth 318, which extend inward from backiron 316 toward a central axis 306. Teeth 318 are disposed about a circumference 304 of stator 300. A plurality of phase windings 312 (stator coil) are wound around on stator teeth 318 for magnetic communication with the internal rotor. Phase windings 312 can have a number of winding configurations, as known. Phase windings 312 are sequentially energized to polarize the stator. A plurality of magnets 220 are disposed in alternating polarity adjacent stators 300. As phase windings 312 are sequentially energized in alternating polarity, the magnetic attraction and repulsion of each stator 300 to the adjacent magnet 220 causes a controlled rotation of hub 212, thereby rotating the disc and passing information to storage tracks beneath the head 120 (FIG. 1).

Motor drive circuitry controls the timing and power of commutation signals directed to phase windings 312. A flexible printed circuit (FPC) 310 carries a plurality of conductors 308 that are electrically connected to start and finish winding terminations. The terminations are electrically connected to phase windings 312 in a known manner.

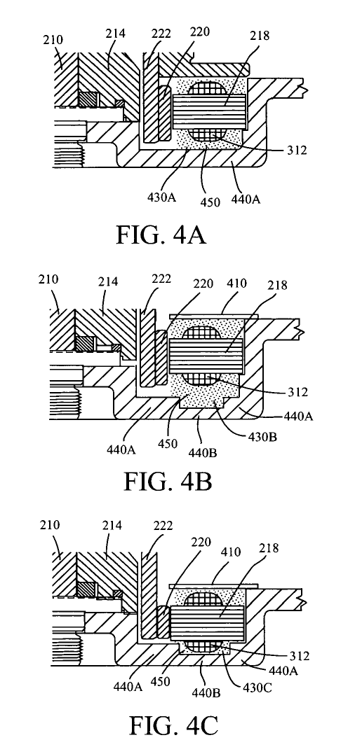

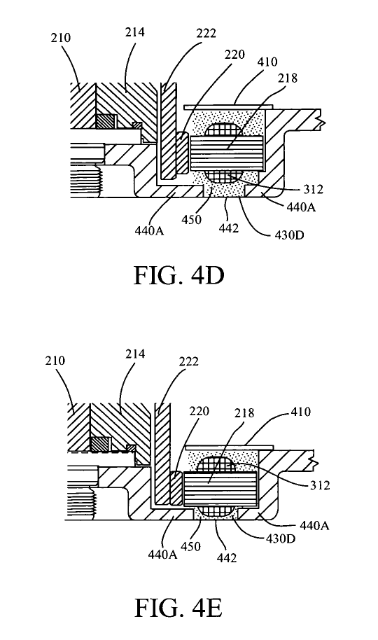

FIG. 4A shows a sectional side view of the hydrodynamic bearing spindle motor of FIG. 2, with a reduced axial height base plate, in an embodiment of the present invention. As used herein, the terms “axially” or “axial direction” refers to a direction along a centerline axis length of the rotating shaft, and “radially” or “radial direction” refers to a direction perpendicular to the centerline length of the rotating shaft.

The present invention makes use of separations and gaps formed in conventional designs. That is, in a conventional stator mounting, stator 218 is mounted to base plate 216 by pressing stator 218 into a cavity such that a projection is compressed against a side wall of base plate 216. Various alternative conventional mounting methods are also utilized to mount stator 218 to base plate 216, including employing O-rings, fasteners and adhesives. Conventionally used mountings of stator 218 results in gaps or separations defined between base plate 216 and stator 218, and about stator 218. One such gap or separation, separation 230 (shown in FIG. 2) is made use of by the present invention for reducing the axial height of the fluid dynamic bearing motor. In one design, separation 230 (an open space or gap having no physical component) is about 0.1 to 0.2 mm. in axial length.

Bonding Substance

In an embodiment, bonding substance 450 is formed about all of stator 218 and fills all of separation 430A between stator 218 and base plate 440A. Stator 218 and base plate 440A are thereby united across separation 430A by bonding substance 450. By “separation” it is meant an intervening space or gap, rather than a physical component. By bonding substance it is meant a physical material that has a discrete existence and can unite two separate components. It is to be appreciated that bonding substance 450, although formed about all of stator 218, is formed to maintain a gap between stator 218 and magnet 220, since these components relatively rotate. In an alternative embodiment, bonding substance 450 is formed about at least a portion of stator 218 and fills at least a portion of separation 430A between stator 218 and base plate 440A, uniting stator 218 and base plate 440A. In another embodiment, bonding substance 450 unites stator 218 and base plate 440A, and is formed about at least a portion of stator 218 and further fills in any gaps between teeth 318, phase windings 312, laminations 314 and backiron 316 (teeth 318, phase windings 312, laminations 314 and backiron 316 are shown in FIG. 3). In a further embodiment, bonding substance 450 fills at least a portion of separation 430A between stator 218 and base plate 440A, and further fills adjacent gaps, other than directly between stator 218 and base plate 440A.

Base Plate Thickness

Bonding substance 450 unites and forms a composite component of stator 218 and base plate 440A such that axial thickness of base plate 440A can be minimized, while base plate stiffness is maintained and vibrations and acoustic vibrations are reduced. Stator 218 and base plate 440A are united across separation 430A, and the axial thickness of base plate 440A is minimized. Base plate 440A of FIG. 4A is intended to show a reduced axial thickness as compared to base plate 216 of FIG. 2. In an embodiment, the axial thickness of base plate 440A is 0.3 mm. (millimeter). In comparison to a conventional one inch disc drive having a 5 mm. thickness and a conventional 0.5 mm. base, a substantial axial space savings (ie., 0.2 mm.) is provided by the present invention. Certainly the axial thickness of base plate 440A can be designed to exceed 0.3 mm as well.

Thermally Conductive Epoxy

Since stator 218 generates heat during spindle motor operation, dissipating heat is necessary. In an embodiment, bonding substance 450 is a thermally conductive epoxy that satisfactorily dissipates heat generated by stator 218. It is to be appreciated that various thermally conductive epoxies can be utilized for bonding substance 450. As an example, epoxies by 3M can be utilized, including TC-2707 and DP-190. TC-2707 has a thermal conductivity of 0.7 W/m-K, and DP-190 grey has a thermal conductivity of 0.4 W/m-K. Additionally, these epoxies provide high bonding strength and stable mechanical performance. Further, these epoxies have strong adhesive and low shrinkage properties. TC-2707 and DP-190 are also electrically insulating and as such are useful to fill a separation between the stator and base plate, to prevent any short circuits. However, the magnetic field and interaction between the stator and the magnet are unaffected by the epoxy.

Improved Stiffness

In an embodiment, axial height of base plate 440A is minimized and base plate 440A stiffness is improved. In another embodiment, the stiffness of base plate 440A is maintained as compared to the stiffness of a base plate having conventional axial thickness. The composite component stator 218, bonding substance 450 and base plate 440A can increase the stiffness of base plate 440A. In an embodiment, the invention provides for adjustment of the axial thickness of base plate to meet axial thickness and stiffness design needs. As described herein, a predefined stiffness is a stiffness substantially analogous to a base plate having a conventional axial thickness (ie., 0.5 mm. in the case of a one inch disc drive, as discussed above) wherein spindle motor design requirements are met including reduced vibration and acoustic vibrations. That is, the described composite base plate is inherently stiff, tending to reduce the spindle motors susceptibility to the excitation of structural mechanical resonances, which reduces undesirable acoustic noise.

Reduced Vibration and Acoustic Vibration

The disc drive industry is focused on reducing the level of acoustic emissions or noise generated by disc drives. One primary source of noise is idle noise, which results from the operation of the spindle motor and its associated rotating discs. The continuous interaction between the stator 218 and the rotor tends to create a torsional resonance in the stator 218. As stator 218 applies a force to the rotor to control the rotational speed of the rotor, a counter-force is applied by the rotor to stator 218 in the opposite direction. This reaction force causes stator 218 to vibrate. Vibrations in stator 218 create acoustic noise by transmission of vibrations to the disc drive housing. Due to the rigid coupling of stator 218 to the base plate 216, stator 218 vibrations transmitted to base plate 216 represent a significant source of acoustic noise. The vibrations to the base plate 216 vibrate together with stator 218 and radiate sound across the larger surface area of the base plate 216.

Another mode of acoustic noise generation is electromagnetic disturbances caused by the excitation of the stator mass by the application and removal of the commutation pulses that are used to drive the motor and control its speed. The commutation pulses are timed, polarization-selected DC current pulses that are directed to sequentially selected stator windings. The rapid rise and fall times of these pulses act as a striking force and set up sympathetic vibrations in the stator structure. Again, the coupling of stator 218 to the base plate 216 causes vibrations to be transmitted to base plate 216. Further, vibration of the media critical affects off track movement of the recording heads. The natural frequency of the media is affected by factors including stiffness of the base plate. The base plate stiffness can significantly affect the lowest vibration mode (rocking mode).

A composite component including stator 218, bonding substance 450 and base plate 440A, provided by an embodiment of the present invention, has satisfactory acoustic impedance, thereby reducing idle noise and other acoustic noise. The ability of the composite component stator 218, bonding substance 450 and base plate 440A to reduce or absorb vibrations has a significant impact on the performance of a disc drive (i.e., the ability of the drive to support high track and bit densities and fast spin rates) as well as on the acoustic noise generated by the drive. Further, bonding substance 450 provides a large surface area over which vibrations from stator 218 and base plate 440A can be damped to reduce acoustic noise generation.

FIG. 4B shows a sectional side view of the hydrodynamic bearing spindle motor of FIG. 2, with a further reduced axial height base plate. Bonding substance 450 unites stator 218 and base plate 440B across separation 430B. In an embodiment, the axial thickness of base plate 440B adjacent to phase windings 312 is in the range of 0.1 to 0.2 mm. In an embodiment, the base plate is increased in axial thickness to about 0.3 mm. at base plate 440A, which is radially adjacent to phase windings 312.

Also shown in FIG. 4B is motor seal 410. The purpose of a motor seal 410 is to shield the disc chamber from dust and metal particles within the motor assembly, and also to shield the magnetic field. Motor seal 410 is shown to illustrate that embodiments of the invention can further include utilizing other stationary components in creating a composite component to increase the stiffness of a minimized base plate. In this example, the composite components (united by bonding substance 450) include stator 218, bonding substance 450, base plate 440A and motor seal 410.

FIG. 4C shows a sectional side view of the hydrodynamic bearing spindle motor of FIG. 4B, with a portion of stator 218 repositioned below an adjacent surface of the base plate, wherein the base plate has a varied axial thickness. In an embodiment, the axial thickness of base plate 440B adjacent to phase windings 312 is in the range of 0.1 to 0.2 mm. Maintaining at least a minimal axial thickness provides satisfactory shaft position tolerance and avoids any fluid leakage. By minimizing a portion of the base plate at base plate 440B and repositioning phase windings 312 below the surface of base plate 440A, an axial reduction and savings of up to 0.4 mm. is provided, as compared to a conventional 0.5 mm. base.

FIG. 4D shows a sectional side view of the hydrodynamic bearing spindle motor of FIG. 2, with a base plate having an epoxy portion. Base plate 440A has an opening or hole, shown as opening 430D, adjacent to phase windings 312, opening 430D filled and sealed with bonding substance 450. Bonding substance 450 unites stator 218 and base plate 440A. Further, bonding substance 450 forms a contiguous base plate by filling opening 430D. In an embodiment, a tape seal 442 is applied to bonding substance 450 extending across opening 430D to base plate 440A. This design can be utilized when a 0.1 mm. axial thickness of base plate adjacent to a stator (as in FIG. 4B and FIG. 4C) presents an excessive manufacturing task due to its thin form. In an embodiment, the base plate is increased in axial thickness to about 0.3 mm. at base plate 440A.

FIG. 4E is a sectional side view of the hydrodynamic bearing spindle motor of FIG. 4D, with a portion of the stator 218 repositioned axially below a surface of base plate 440A to reduce space. Phase windings 312 are positioned within opening 430D. As may be observed, axial space occupied by this portion of the spindle motor is reduced. In an embodiment, bonding substance 450 also occupies opening 430D to unite stator 218 and base plate 440A.

While FIG. 4A-4E describe the present invention with regard to a design wherein the rotor magnet is radially positioned between the shaft and the stator (stator external to the hub), it is to be appreciated that embodiments of the present invention can be utilized with various other spindle motor designs, including a spindle motor having a stator radially positioned between the shaft and the magnet (stator internal to the rotor).

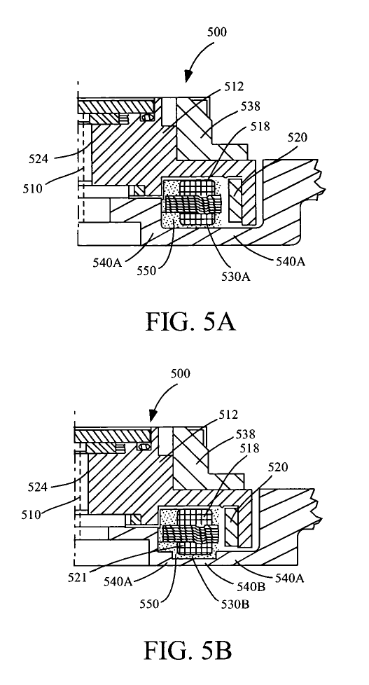

FIG. 5A shows a sectional view of a portion of a rotating sleeve 512 hydrodynamic bearing spindle motor 500 with a reduced axial height base plate 540A, and having a magnet 520 positioned radially outside a stator 518. Rotating sleeve 512 defines a hydrodynamic bearing 524 with stationary shaft 510. Disc carrying member 538 supports a disc pack and is attached to, and rotates with, rotating sleeve 512.

Bonding substance 550 is formed about at least a portion of stator 518 and fills at least a portion of separation 530A between stator 518 and base plate 540A. Bonding substance 550 unites and forms a composite component of stator 518 and base plate 540A such that axial thickness of base plate 540A can be minimized, while base plate stiffness is maintained and vibrations and acoustic vibrations are reduced. Base plate 540A of FIG. 5A is intended to show a reduced axial thickness as compared to base plate 216 of FIG. 2. In an embodiment, the axial thickness of base plate 540A is 0.3 mm.

FIG. 5B shows another view of the spindle motor of FIG. 5A in which the axial height of a portion of the base plate is further reduced at base plate 540B. A portion of the stator is repositioned below an adjacent surface of the base plate 540A. Phase windings 521 are positioned within separation 530B, separation 530B defined by the axial thickness reduction at base plate 540B. The axial height of spindle motor 500 is thereby reduced. Bonding substance 550 unites stator 518 and base plate 540B across separation 530B. The axial thickness of base plate 540B adjacent to phase windings 521 is in the range of 0.1 mm to 0.2 mm. In an embodiment, the base plate is increased in axial thickness to about 0.3 mm. at base plate 540A.

Other features and advantages of this invention will be apparent to a person of skill in the art who studies this disclosure. For example, it is to be appreciated that bonding substance 450 (FIG. 4B) can be utilized to unite and increase stiffness of the base plate 440B by uniting additional stationary components adjacent to stator 218 and base plate 440B. For example, in an embodiment, bonding substance 450 unites stator 218, base plate 440B and a motor seal 410. (shown in FIG. 4B). Thus, exemplary embodiments, modifications and variations may be made to the disclosed embodiments while remaining within the spirit and scope of the invention as defined by the appended claims.

We claim:

1. A spindle motor comprising:
a rotatable component defining a bearing gap and relatively rotatable with a stationary component;
a base plate affixed to the stationary component;
a stator, affixed to the stationary component, for generating an electromagnetic force that interacts with the rotatable component and drives the rotatable component, wherein the stator and the base plate define a separation there between; and
a bonding substance, formed about at least a portion of the stator, filling at least a portion of the separation and uniting the base plate and the stator.

2. The spindle motor as in claim 1, wherein axial thickness of the base plate is minimized adjacent to the separation.

3. The spindle motor as in claim 1, wherein the bonding substance comprises a thermally conductive epoxy having a high bonding strength.

4. The spindle motor as in claim 3, wherein the thermally conductive epoxy comprises one of TC-2707 and DP-190.

5. The spindle motor as in claim 1, wherein the bonding substance is formed substantially about the stator, and the bonding substance further unites a motor seal affixed to the base plate.

6. The spindle motor as in claim 2, wherein the axial thickness of at least a portion of the base plate is in the range of 0.1 mm. to 0.3 mm.

7. The spindle motor as in claim 1, wherein a portion of the base plate adjacent to the separation defines an opening that is substantially filled with the bonding substance, and the bonding substance forms a contiguous base plate.

8. The spindle motor as in claim 2, wherein a portion of the stator is positioned below an adjacent surface of the base plate, wherein the base plate has a varied axial thickness.

9. A spindle motor for incorporation into a disc drive storage system comprising:
a rotatable component defining a bearing gap and relatively rotatable with a stationary component;
a base plate affixed to the stationary component;
a data storage disc attached to the rotatable component;
a stator, affixed to the stationary component, for generating an electromagnetic force that interacts with the rotatable component and drives the rotatable component, wherein the stator and the base plate define a separation there between; and
a bonding substance, formed about at least a portion of the stator, filling at least a portion of the separation and uniting the base plate and the stator.

10. The spindle motor as in claim 9, wherein axial thickness of the base plate is minimized adjacent to the separation.

11. The spindle motor as in claim 9, wherein the bonding substance comprises a thermally conductive epoxy having a high bonding strength.

12. The spindle motor as in claim 11, wherein the thermally conductive epoxy comprises one of TC-2707 and DP-190.

13. The spindle motor as in claim 9, wherein the bonding substance is formed substantially about the stator, and the bonding substance further unites a motor seal affixed to the base plate.

14. The spindle motor as in claim 10, wherein the axial thickness of at least a portion of the base plate is in the range of 0.1 mm. to 0.3 mm.

15. The spindle motor as in claim 9, wherein a portion of the base plate adjacent to the separation defines an opening that is substantially filled with the bonding substance, and the bonding substance forms a contiguous base plate.

16. The spindle motor as in claim 10, wherein a portion of the stator is positioned below an adjacent surface of the base plate, wherein the base plate has a varied axial thickness.

17. A method comprising:
defining a bearing gap between a rotatable component and a stationary component;
affixing a base plate to the stationary component;
affixing a stator to the stationary component, for generating an electromagnetic force that interacts with the rotatable component and drives the rotatable component;
forming a bonding substance about at least a portion of the stator;
filling with the bonding substance at least a portion of a separation defined between the stator and the base plate; and
uniting the base plate and the stator.

18. The method as in claim 17, further comprising minimizing axial thickness of the base plate adjacent to the separation.

19. The method as in claim 17, further comprising utilizing a thermally conductive epoxy having a high bonding strength for the bonding substance.

20. The method as in claim 18, further comprising positioning a portion of the stator below an adjacent surface of the base plate, wherein the base plate has a varied axial thickness.

21. The method as in claim 18, wherein at least a portion of the base plate is formed having an axial thickness in the range of 0.1 mm. to 0.3 mm.

22. The method as in claim 17, further comprising forming an opening through the portion of the base plate adjacent to the separation, substantially filling the opening with the bonding substance, and forming a contiguous base plate with the bonding substance.
